(19) United States
(12) Patent Application Publication
(10) Pub. No.: US 2025/0162058 A1
(43) Pub. Date: May 22, 2025

(54) VISUAL DYNAMIC POSITIONING SYSTEM FOR A PIPE CUTTING PLASMA MACHINE

(71) Applicant: Benjamin G. Stroyer, East Rochester, NY (US)

(72) Inventor: Benjamin G. Stroyer, East Rochester, NY (US)

(21) Appl. No.: 18/946,339

(22) Filed: Nov. 13, 2024

Related U.S. Application Data
(60) Provisional application No. 63/601,188, filed on Nov. 20, 2023.

(51) Int. Cl. B23K 10/00; B23K 37/053; B23K 101/10

(52) U.S. Cl. CPC B23K 10/006; B23K 37/053; B23K 2101/10

(57) ABSTRACT

A pipe cutting plasma machine includes a V-rollers platform configured to move and rotate a pipe located thereon; a gantry having a plasma torch configured to cut the pipe located on the V-rollers platform; and a visual dynamic positioning system, operatively connected to the gantry, configured to detect and measure, before the plasma torch cuts a first through coupling hole in the pipe, bowness of the pipe located on the V-rollers platform. The visual dynamic positioning system includes an imaging device configured to image the pipe and generate image data signals therefrom, an image processor configured to detect and measure, based upon the generated image data signals, the bowness of the pipe and to generate control signals corresponding to the detected and measured bowness of the pipe, and a gantry controller configured to bi-directionally move the gantry based upon the generated control signals.

### PRIORITY INFORMATION

The present application claims priority, under 35 U.S.C. § 119(e), from U.S. Provisional Patent Application Ser. No. 63/601,188, filed on Nov. 20, 2023. The entire content of US Provisional Patent Application Ser. No. 63/601, 188, filed on Nov. 20, 2023, is hereby incorporated by reference.

### BACKGROUND

Conventionally, a pipe cutting plasma machine uses a plasma torch to cut holes into a pipe. The pipe rolls in, on V-rollers, up to a chuck where the pipe is clamped. An operator then moves a gantry, which includes the plasma torch, out to the end of the pipe where the plasma torch will make holes in the pipe.

The holes are made, where the pipe cutting plasma machine believes is the center of the pipe. Thereafter, the pipe is rotated 180° to cut a second hole. A bolt should go directly through the exact center of the pipe to make an accurate through coupling hole for a bolted coupling.

In a conventional pipe cutting plasma machine, the height of the plasma torch is controlled. Moreover, the X-Y-Z movement of the gantry and the rotation of the chuck are controlled in a conventional pipe cutting plasma machine.

Although conventional pipe cutting plasma machines control the various movements of the gantry and the pipe to be processed, the conventional pipe cutting plasma machines fail to compensate for possible bowing of the pipe. A bowed pipe, using a conventional pipe cutting plasma machine, can cause the cut holes to be off-cantered such that through-bolt coupling cannot be realized.

More specifically, when a bowed pipe is cut using a conventional pipe cutting plasma machine, the opposing holes are not aligned such that through-bolt coupling cannot be realized.

Thus, it is desirable to provide a pipe cutting plasma machine which can compensate for bowed pipes and generate aligned holes for through-bolt coupling.

Additionally, it is desirable to provide a system that detects a bowed pipe and corrects alignment of a plasma torch of a conventional pipe cutting plasma machine such that cut opposing holes are aligned and through-bolt coupling can be realized.

### BRIEF DESCRIPTION OF THE DRAWINGS

The drawings are only for purposes of illustrating various embodiments and are not to be construed as limiting, wherein:

FIG. 1 illustrates a conventional pipe cutting plasma machine with a non-bowed pipe;

FIG. 2 illustrates a conventional pipe cutting plasma machine cutting a through coupling hole in a bowed pipe;

FIG. 3 illustrates the conventional pipe cutting plasma machine of FIG. 2 cutting an opposing through coupling hole in the bowed pipe;

FIG. 4 illustrates non-alignment of through-bolts for coupling for a bowed pipe cut by a conventional pipe cutting plasma machine;

FIG. 5 illustrates a pipe cutting plasma machine with a visual dynamic positioning system with an unbowed pipe;

FIG. 6 illustrates a pipe cutting plasma machine with a visual dynamic positioning system determining the presence of a bowed pipe;

FIG. 7 illustrates a pipe cutting plasma machine with a visual dynamic positioning system cutting a through coupling hole in the bowed pipe;

FIG. 8 illustrates a pipe cutting plasma machine with a visual dynamic positioning system cutting a through coupling hole in the bowed pipe corresponding to the through coupling hole cut in FIG. 7; and

FIG. 9 illustrates alignment of through-bolts for coupling a bowed pipe cut by the pipe cutting plasma machine with a visual dynamic positioning system with a bowed or non-bowed pipe cut by the pipe cutting plasma machine with a visual dynamic positioning system.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

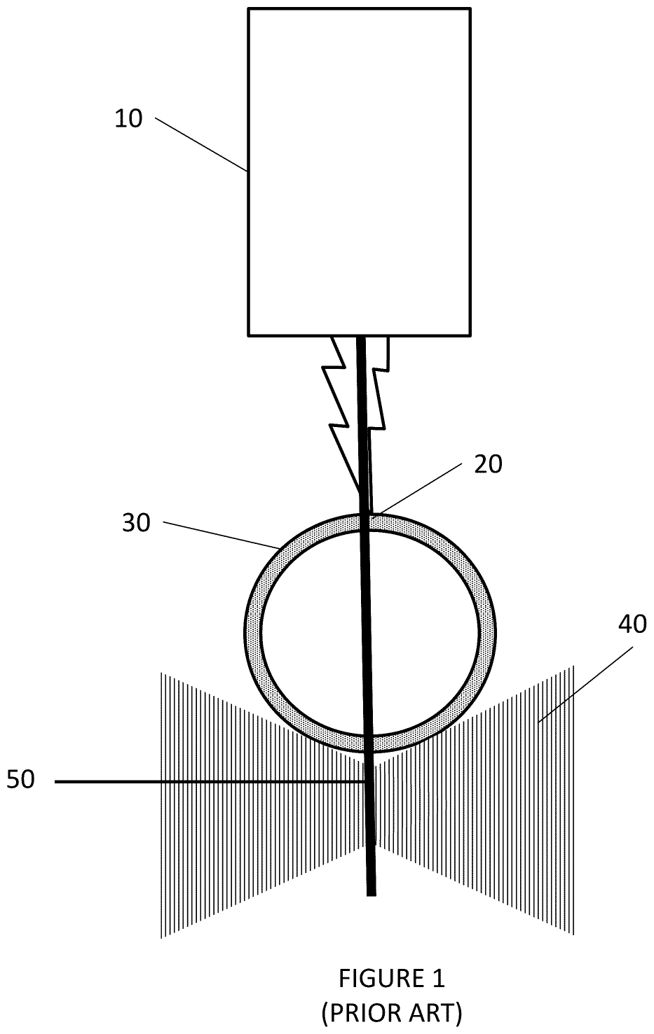

FIG. 1 illustrates a conventional pipe cutting plasma machine with a non-bowed pipe. As illustrated in FIG. 1, a conventional pipe cutting plasma machine includes a gantry 10 having a plasma torch 20 for cutting pipe 30. The conventional pipe cutting plasma machine also includes a V-rollers platform 40 having a vertical center axis 50. The conventional pipe cutting plasma machine uses the vertical center axis 50 of the V-rollers platform 40 as the theoretical center of the pipe 30.

As illustrated in FIG. 1, the pipe 30 is non-bowed. Since the conventional pipe cutting plasma machine uses the vertical center axis 50 of the V-rollers platform 40 as the theoretical center of the pipe 30 and FIG. 1 illustrates non-bowed pipe 30, the cut through coupling holes will properly align, enabling through-bolt coupling.

With respect to FIG. 1, the plasma torch 20 cuts a first through coupling hole in pipe 30. Thereafter, the V-rollers platform 40 rotates pipe 30 180° so that the plasma torch 20 is able to cut a second through coupling hole, the second through coupling hole corresponding to the first through coupling hole, in pipe 30. Since pipe 30 is not bowed, the cut first through coupling hole and the cut second through coupling hole are aligned, thereby allowing coupling to another pipe via a through bolt.

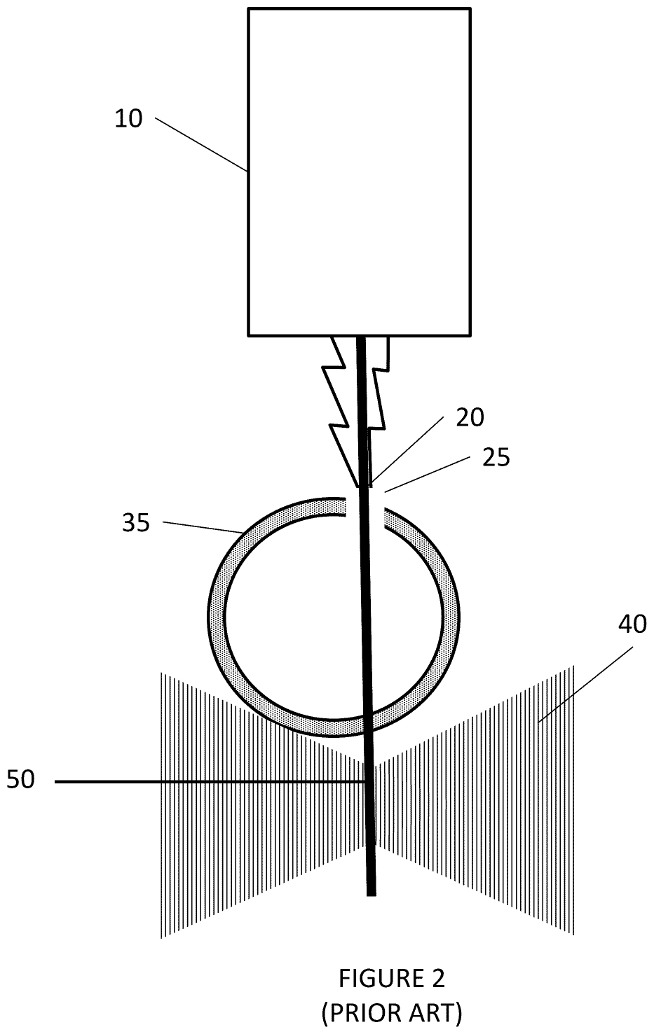

FIG. 2 illustrates a conventional pipe cutting plasma machine cutting a hole in a bowed pipe. As illustrated in FIG. 2, a conventional pipe cutting plasma machine includes a gantry 10 having a plasma torch 20 for cutting bowed pipe 35. The conventional pipe cutting plasma machine also includes a V-rollers platform 40 having a vertical center axis 50. The conventional pipe cutting plasma machine uses the vertical center axis 50 of the V-rollers platform 40 as the theoretical center of bowed pipe 35.

As illustrated in FIG. 2, pipe 35 is bowed (off-center of the V-rollers platform 40). Since the conventional pipe cutting plasma machine uses the vertical center axis 50 of the V-rollers platform 40 as the theoretical center of the bowed pipe 35 and FIG. 2 illustrates bowed pipe 35, the cut through coupling hole 25 is not the center of the bowed pipe 35 due to the orientation of the bowed pipe 35 with respect to the vertical center axis 50 of the V-rollers platform 40.

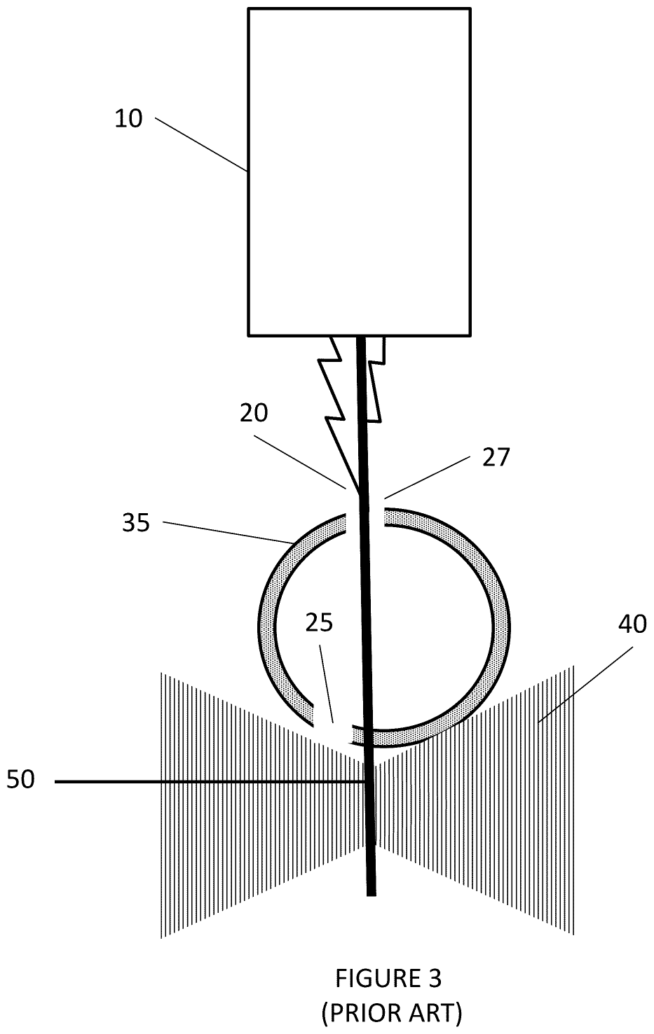

FIG. 3 illustrates the conventional pipe cutting plasma machine of FIG. 2 cutting an opposing (corresponding) through coupling hole in the bowed pipe. As illustrated in FIG. 3, the conventional pipe cutting plasma machine of FIG. 3 includes a gantry 10 having a plasma torch 20 for cutting pipe 35, which has been rotated 180° from its position in FIG. 2. The conventional pipe cutting plasma machine also includes a V-rollers platform 40 having a vertical center axis 50. The conventional pipe cutting plasma machine uses the vertical center axis 50 of the V-rollers platform 40 as the theoretical center of the pipe 35.

As illustrated in FIG. 3, the pipe 35 is bowed (off-center of the V-rollers platform 40) and has been rotated 180° from its position in FIG. 2. Since the conventional pipe cutting plasma machine uses the vertical center axis 50 of the V-rollers platform 40 as the theoretical center of the pipe 35 and FIG. 3 illustrates bowed pipe 35 having been rotated 180° from its position in FIG. 2, the cut through coupling hole 27 is not the center of the bowed pipe 35 due to the orientation of the bowed pipe 35 with respect to the vertical center axis 50 of the V-rollers platform 40.

Moreover, the previous cut through coupling hole 25 is not the center of the bowed pipe 35 due to the orientation of the bowed pipe 35 with respect to the vertical center axis 50 of the V-rollers platform 40.

With respect to FIGS. 2 and 3, the plasma torch 20 cuts a first through coupling hole 25 in pipe 35. Thereafter, the V-rollers platform 40 rotates pipe 35 180° so that the plasma torch 20 is able to cut a second through coupling hole 27, the second through coupling hole 27 corresponding to the first through coupling hole 25, in pipe 35. Since pipe 35 is bowed, the cut first through coupling hole 25 and the cut second through coupling hole 27 are not aligned, thereby preventing the coupling to another pipe via a through bolt.

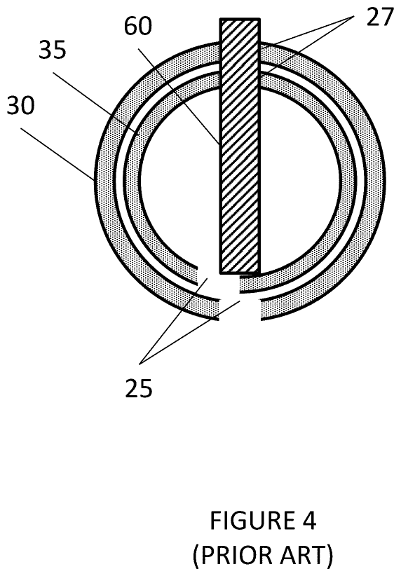

FIG. 4 illustrates non-alignment of through bolts for coupling for a bowed pipe cut by a conventional pipe cutting plasma machine with a non-bowed pipe cut by a conventional pipe cutting plasma machine. As illustrated in FIG. 4, a non-bowed pipe 30 (outer pipe) and a bowed pipe 35 (inner pipe) have been cut using a conventional pipe cutting plasma machine. The cut through coupling hole 25 and the cut through coupling hole 27 of the non-bowed pipe 30 are not aligned with the cut through coupling hole 25 and the cut through coupling hole 27 of the bowed pipe 35, thereby preventing through-bolt coupling between two pipes.

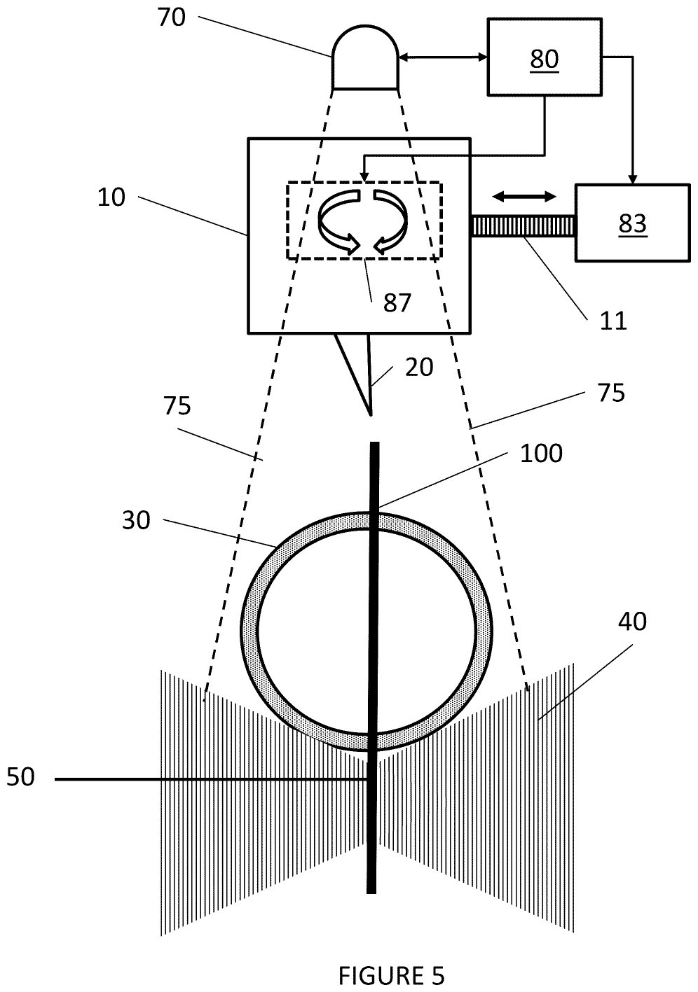

FIG. 5 illustrates a pipe cutting plasma machine with a visual dynamic positioning system. As illustrated in FIG. 5, a pipe cutting plasma system includes a gantry 10, which is horizontally movable. The gantry 10 has a plasma torch 20 for cutting a pipe 35. A gantry controller/motor 83, such as a linear actuator, is operationally connected to the gantry 10, to bi-directionally move the gantry 10 horizontally along rails 11.

The gantry 10 also a torch orientation controller/motor 87. The torch orientation controller/motor 87 bi-directionally rotates the gantry 10 to orientate the plasma torch 20 such that the plasma torch 20 is positioned to be substantially perpendicular to a surface of pipe 30.

The pipe cutting plasma machine also includes a V-rollers platform 40 having a vertical center axis 50. As noted above, a conventional pipe cutting plasma machine uses the vertical center axis 50 of the V-rollers platform 40 as the theoretical center of the pipe 30.

As illustrated in FIG. 5, the pipe cutting plasma system includes a visual dynamic positioning system. The visual dynamic positioning system includes an imaging device 70. The imaging device 70 detects and measures a three-dimensional position of the pipe 30 within a field of view 75 of the imaging device 70 to create three-dimensional image data. The imaging device 70 outputs the three-dimensional image data to a processor 80, which determines the “bowness” of the pipe 30 based upon the vertical center axis 50 of the V-rollers platform 40 with respect to the three-dimensional position of the pipe 30 within a field of view 75 of the imaging device 70.

The imaging device 70 can be a non-laser based imaging system for detecting and measuring the three-dimensional position of the pipe 30 within the field of view 75 of the imaging device 70. Alternatively, the imaging device 70 is, preferably, a laser-based system for detecting and measuring the three-dimensional position of the pipe 30 within the field of view 75 of the imaging device 70.

As illustrated in FIG. 5, if a center point 100 of the pipe 30, when the pipe 30 is positioned on the V-rollers platform 40, wherein the center point 100 of the pipe 30 is the point on the pipe 30 that is closest to the imaging device 70, lines up with the vertical center axis 50 of the V-rollers platform 40, the processor 80 determines that the pipe 30 is not bowed and ready to have through coupling holes cut therein without any adjustment to the plasma torch 20 of the gantry 10.

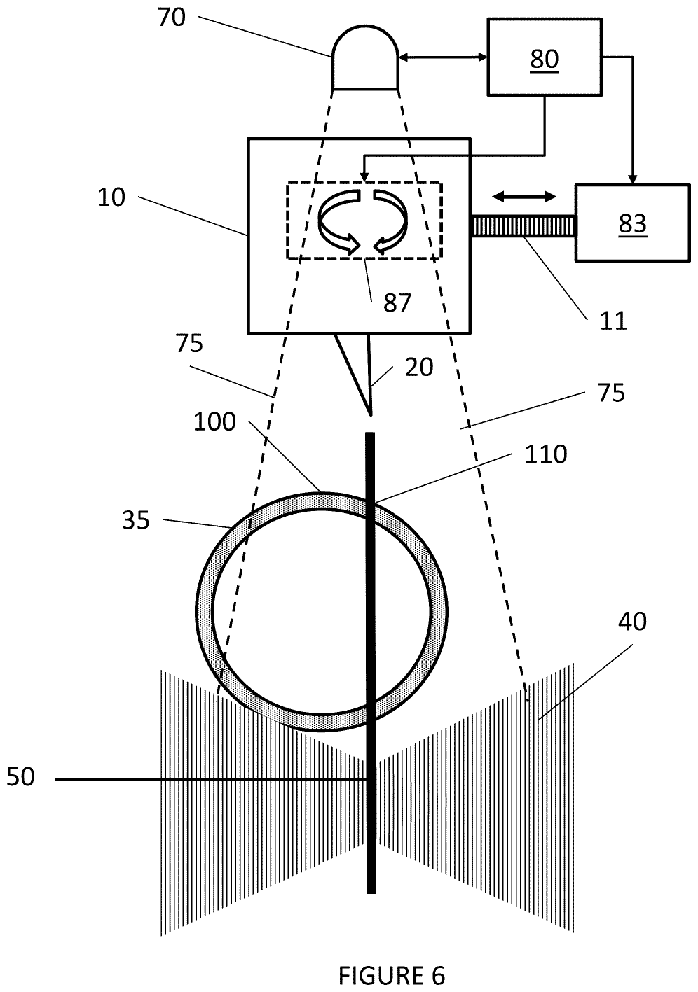

FIG. 6 illustrates a pipe cutting plasma machine with a visual dynamic positioning system and a pipe 35. As illustrated in FIG. 6, the pipe 35 is bowed, wherein a portion of bowed pipe 35 is outside the field of view 75 of the imaging device 70, and the center point 100 of the pipe 35 is off-centered or offset, in a horizontal direction, with respect to the vertical center axis 50 of the V-rollers platform 40.

Without the visual dynamic positioning system, a conventional pipe cutting plasma system would cut a bolt through coupling hole, at point 110, in alignment with the vertical center axis 50 of the V-rollers platform 40. However, by cutting a bolt through coupling hole, at point 110, in alignment with the vertical center axis 50 of the V-rollers platform 40, the bolt through coupling hole would not be aligned with the center of the pipe 35, thereby preventing through-bolt coupling between two pipes.

With the visual dynamic positioning system, the visual dynamic positioning system, via imaging device 70 and processor 80, detects and measures the bow of pipe 35. Based upon the detected and measured bow of pipe 35, the processor 80 provides correction data (signals) to the gantry controller 83 and the torch orientation controller/motor 87.

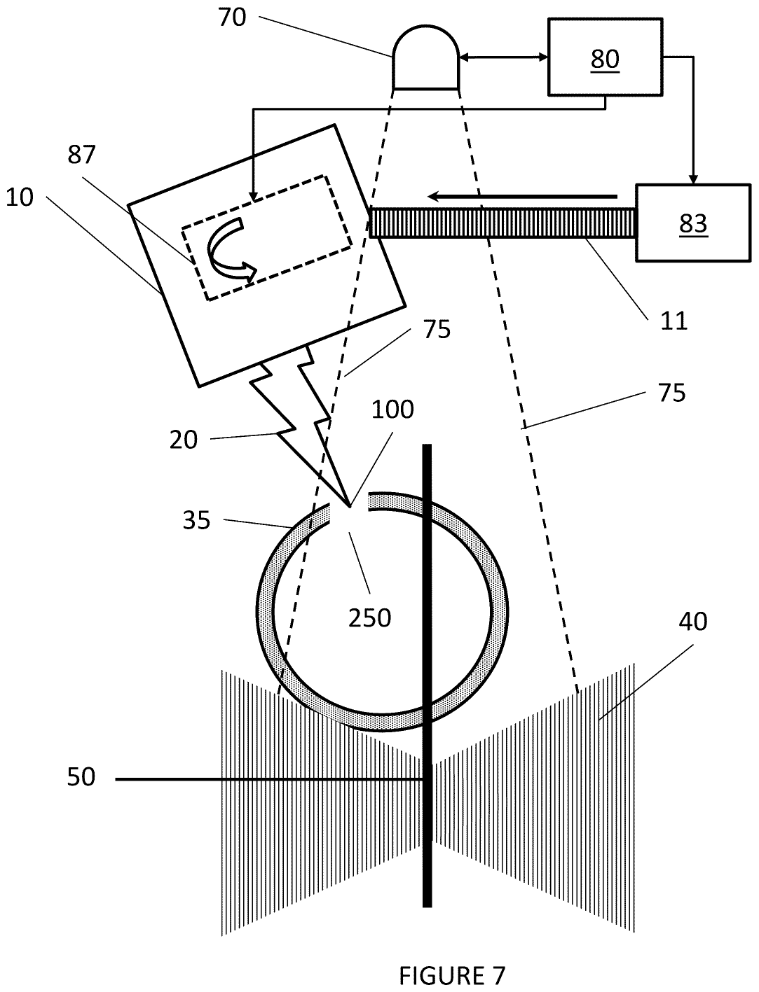

FIG. 7 illustrates the visual dynamic positioning system compensating for the measured bow in pipe 35 to cut a proper through coupling hole. As illustrated in FIG. 7, the pipe 35 is bowed, wherein a portion of bowed pipe 35 is outside the field of view 75 of the imaging device 70, and the center point 100 of the pipe 35 is off-centered or offset, in a horizontal direction, with respect to the vertical center axis 50 of the V-rollers platform 40.

The visual dynamic positioning system, via imaging device 70 and processor 80, detects and measures the bow of pipe 35. Based upon the detected and measured bow of pipe 35, the processor 80 provides correction data (signals) to the gantry controller 83 and the torch orientation controller/motor 87.

The gantry controller 83, based upon the received correction data (signals), moves, as illustrated in FIG. 7, the gantry 10 along the rails 11 such that the plasma torch 20 is properly lined up to cut through coupling hole 250.

The torch orientation controller/motor 87, based upon the received correction data (signals), rotates (if necessary), as illustrated in FIG. 7, the gantry 10 such that the plasma torch 20 is properly lined up to cut through coupling hole 250.

As illustrated in FIG. 7, the visual dynamic positioning system compensates for the bow in pipe 35 and moves and/or rotates the gantry 10 so that the plasma torch 20 is properly lined up to cut through coupling hole 250 in bowed pipe 35.

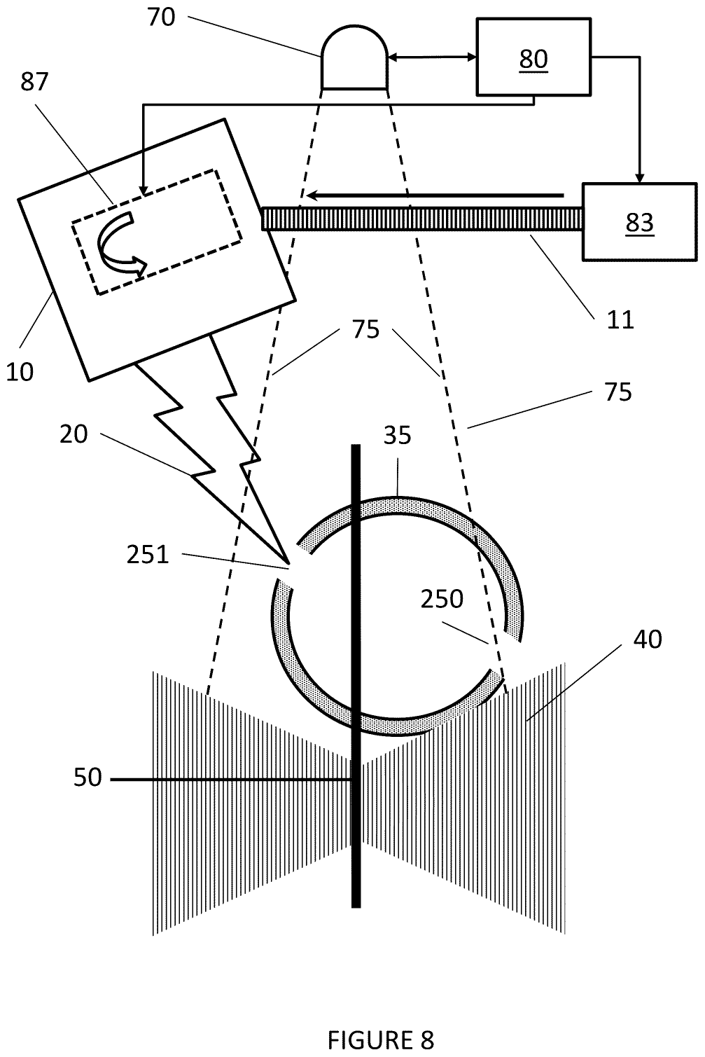

FIG. 8 illustrates the visual dynamic positioning system compensating for the measured bow in pipe 35 to cut a proper through coupling hole, wherein bowed pipe 35 has been rotated 180°. As illustrated in FIG. 8, the pipe 35 is bowed, wherein a portion of bowed pipe 35 is outside the field of view 75 of the imaging device 70, and the center point 100 of the pipe 35 is off-centered or offset, in a horizontal direction, with respect to the vertical center axis 50 of the V-rollers platform 40. The visual dynamic positioning system, via imaging device 70 and processor 80 and based upon the previously measured bow before the 180° rotation, detects and measures the bow of pipe 35. Based upon the measured bow of pipe 35, the processor 80 provides correction data (signals) to the gantry controller 83 and the torch orientation controller/motor 87.

The gantry controller 83, based upon the received correction data (signals), moves, as illustrated in FIG. 8, the gantry 10 along the rails 11 such that the plasma torch 20 is properly lined up with the location of through coupling hole 251, through coupling hole 251 corresponding to through coupling hole 250 cut in FIG. 7, of bowed pipe 35.

The torch orientation controller/motor 87, based upon the received correction data (signals), rotates (if necessary), as illustrated in FIG. 8, the gantry 10 such that the plasma torch 20 is properly lined up to cut through coupling hole 251, cut through coupling hole 251 corresponding to and being diametrically opposed to through coupling hole 250 cut in FIG. 7, of bowed pipe 35.

As illustrated in FIG. 8, the visual dynamic positioning system compensates for the bow in pipe 35 and moves and/or rotates the gantry 10 so that the plasma torch 20 is properly lined up to cut through coupling hole 251, through coupling hole 251 corresponding to through coupling hole 250 cut in FIG. 7, of bowed pipe 35.

As described above, the visual dynamic positioning system detects and measures the orientation of the element being worked on with respect to the vertical center axis of the V-rollers platform. The visual dynamic positioning system outputs information to direct the tooling (gantry and plasma torch) to the proper position with respect to the center of the element.

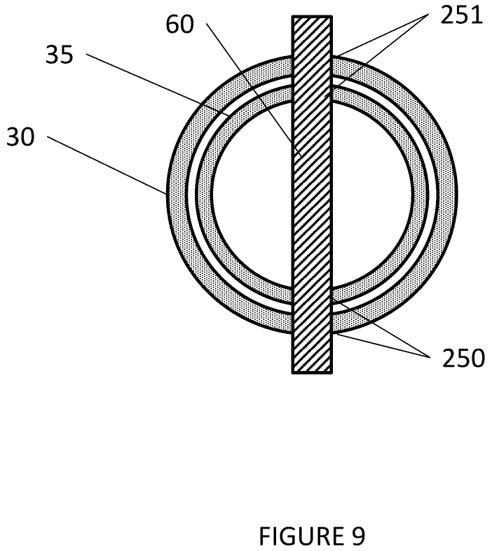

FIG. 9 illustrates alignment of through bolts for coupling for a non-bowed pipe cut by a conventional pipe cutting plasma machine. As illustrated in FIG. 9, a non-bowed pipe 30 has been cut using a pipe cutting plasma machine with the visual dynamic positioning system, and a bowed pipe 35 has been cut using a pipe cutting plasma machine with the visual dynamic positioning system. The cut through coupling holes 250 of the non-bowed pipe 30 and bowed pipe 35 are aligned with the cut through coupling holes 251 of the non-bowed pipe 30 and bowed pipe 35, thereby enabling through-bolt 60 to pass therethrough and couple the pipes (30 and 35).

A pipe cutting plasma machine comprises a V-rollers platform configured to move and rotate a pipe located thereon; a gantry having a plasma torch configured to cut the pipe located on the V-rollers platform; and a visual dynamic positioning system, operatively connected to the gantry, configured to detect and measure, before the plasma torch cuts a first through coupling hole in the pipe, bowness of the pipe located on the V-rollers platform; the V-rollers platform having a vertical center axis and the pipe, located on the V-rollers platform, having a vertical center; the visual dynamic positioning system determining the pipe, located on the V-rollers platform, as being bowed when the vertical center of the pipe is offset, in a horizontal direction, from the vertical center axis of the V-rollers platform; the visual dynamic positioning system including an imaging device configured to image the pipe located on the V-rollers platform and generate image data signals therefrom, an image processor, operatively connected to the imaging device, configured to detect and measure, based upon the generated image data signals from the imaging device, the bowness of the pipe located on the V-rollers platform and to generate control signals corresponding to the detected and measured bowness of the pipe located on the V-rollers platform, and a gantry controller, operatively connected to the image processor, configured to bi-directionally move the gantry based upon the generated control signals corresponding to the detected and measured bowness of the pipe located on the V-rollers platform.

The visual dynamic positioning system may further include a torch orientation controller/motor, operatively connected to the image processor, configured to bi-directionally rotate the gantry based upon the generated control signals corresponding to the detected and measured bowness of the pipe located on the V-rollers platform.

The imaging device may be a non-laser based imaging device. The imaging device may be a laser based imaging device.

The gantry controller may be a linear actuator.

The V-rollers platform may be configured to rotate the pipe located thereon 180° after the plasma torch cuts first through coupling hole in the pipe; the visual dynamic positioning system being configured to detect and measure, after the V-rollers platform rotates the pipe located thereon 180° and before the plasma torch cuts a second through coupling hole in the pipe, bowness of the pipe located on the V-rollers platform.

A method for cutting through coupling holes in a pipe with a pipe cutting plasma machine, comprises (a) moving, using a V-rollers platform, a pipe to locate a desired section of the pipe under a gantry having a plasma torch configured to cut the pipe, the V-rollers platform having a vertical center axis and the pipe, located on the V-rollers platform, having a vertical center; (b) detecting and measuring, using a visual dynamic positioning system, before the plasma torch cuts a first through coupling hole in the pipe, bowness of the pipe located on the V-rollers platform by (b1) imaging the pipe located on the V-rollers platform and generating image data signals therefrom, and (b2) detecting and measuring, based upon the generated image data signals, the bowness of the pipe located on the V-rollers platform, the being determined to be bowed when the vertical center of the pipe is offset, in a horizontal direction, from the vertical center axis of the V-rollers platform; (c) generating control signals corresponding to the detected and measured bowness of the pipe located on the V-rollers platform; (d) bi-directionally moving the gantry, based upon the generated control signals corresponding to the detected and measured bowness of the pipe located on the V-rollers platform, to move the plasma torch to a location to cut the first through coupling hole in the pipe at the vertical center of the pipe; and (e) cutting, using the plasma torch, the first through coupling hole in the pipe at the vertical center of the pipe.

The method may further comprise (f) rotating, using the V-rollers platform, the pipe 180° after the plasma torch cuts the first through coupling hole in the pipe; (g) detecting and measuring, after the V-rollers platform rotates the pipe located thereon 180° and before the plasma torch cuts a second through coupling hole in the pipe, bowness of the pipe located on the V-rollers platform and generating control signals corresponding to the detected and measured bowness of the pipe located on the V-rollers platform after rotation; (h) bi-directionally moving the gantry, based upon the generated control signals corresponding to the detected and measured bowness of the pipe located on the V-rollers platform after rotation, to move the plasma torch to a location to cut the second through coupling hole in the pipe; and (i) cutting, using the plasma torch, the second through coupling hole in the pipe such that the second through coupling hole diametrically opposes the first through coupling hole.

The method may further comprise (f) bi-directionally rotating, before the plasma torch cuts the first through coupling hole in the pipe, the gantry, using a torch orientation controller, based upon the generated control signals corresponding to the detected and measured bowness of the pipe located on the V-rollers platform.

The detecting and measuring bowness of the pipe located on the V-rollers platform may use a non-laser based imaging device. The detecting and measuring bowness of the pipe located on the V-rollers platform may use a laser based imaging device.

It will be appreciated that several of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

1. A pipe cutting plasma machine comprising:
a V-rollers platform configured to move and rotate a pipe located thereon;
a gantry having a plasma torch configured to cut the pipe located on said V-rollers platform; and
a visual dynamic positioning system, operatively connected to said gantry, configured to detect and measure, before said plasma torch cuts a first through coupling hole in the pipe, bowness of the pipe located on said V-rollers platform;
said V-rollers platform having a vertical center axis and the pipe, located on said V-rollers platform, having a vertical center;
said visual dynamic positioning system determining the pipe, located on said V-rollers platform, as being bowed when the vertical center of the pipe is offset, in a horizontal direction, from said vertical center axis of said V-rollers platform;
said visual dynamic positioning system including
an imaging device configured to image the pipe located on said V-rollers platform and generate image data signals therefrom,
an image processor, operatively connected to said imaging device, configured to detect and measure, based upon the generated image data signals from said imaging device, the bowness of the pipe located on said V-rollers platform and to generate control signals corresponding to the detected and measured bowness of the pipe located on said V-rollers platform, and
a gantry controller, operatively connected to said image processor, configured to bi-directionally move said gantry based upon the generated control signals corresponding to the detected and measured bowness of the pipe located on said V-rollers platform.

2. The pipe cutting plasma machine, as claimed in claim 1, wherein said visual dynamic positioning system further includes a torch orientation controller/motor, operatively connected to said image processor, configured to bi-directionally rotate said gantry based upon the generated control signals corresponding to the detected and measured bowness of the pipe located on said V-rollers platform.

3. The pipe cutting plasma machine, as claimed in claim 1, wherein said imaging device is a non-laser based imaging device.

4. The pipe cutting plasma machine, as claimed in claim 1, wherein said imaging device is a laser based imaging device.

5. pipe cutting plasma machine, as claimed in claim 2, wherein said imaging device is a non-laser based imaging device.

6. The pipe cutting plasma machine, as claimed in claim 2, wherein said imaging device is a laser based imaging device.

7. The pipe cutting plasma machine, as claimed in claim 1, wherein said gantry controller is a linear actuator.

8. The pipe cutting plasma machine, as claimed in claim 1, wherein said V-rollers platform being configured to rotate the pipe located thereon 180° after said plasma torch cuts first through coupling hole in the pipe;
said visual dynamic positioning system being configured to detect and measure, after said V-rollers platform rotates the pipe located thereon 180° and before said plasma torch cuts a second through coupling hole in the pipe, bowness of the pipe located on said V-rollers platform.

9. A method for cutting through coupling holes in a pipe with a pipe cutting plasma machine, comprising:
(a) moving, using a V-rollers platform, a pipe to locate a desired section of the pipe under a gantry having a plasma torch configured to cut the pipe, the V-rollers platform having a vertical center axis and the pipe, located on the V-rollers platform, having a vertical center;
(b) detecting and measuring, using a visual dynamic positioning system, before the plasma torch cuts a first through coupling hole in the pipe, bowness of the pipe located on the V-rollers platform by
(b1) imaging the pipe located on the V-rollers platform and generating image data signals therefrom, and
(b2) detecting and measuring, based upon the generated image data signals, the bowness of the pipe located on the V-rollers platform, the being determined to be bowed when the vertical center of the pipe is offset, in a horizontal direction, from the vertical center axis of the V-rollers platform;
(c) generating control signals corresponding to the detected and measured bowness of the pipe located on the V-rollers platform;
(d) bi-directionally moving the gantry, based upon the generated control signals corresponding to the detected and measured bowness of the pipe located on the V-rollers platform, to move the plasma torch to a location to cut the first through coupling hole in the pipe at the vertical center of the pipe; and
(e) cutting, using the plasma torch, the first through coupling hole in the pipe at the vertical center of the pipe.

10. The method as claimed in claim 9, further comprising:
(f) rotating, using the V-rollers platform, the pipe 180° after the plasma torch cuts the first through coupling hole in the pipe;
(g) detecting and measuring, after the V-rollers platform rotates the pipe located thereon 180° and before the plasma torch cuts a second through coupling hole in the pipe, bowness of the pipe located on the V-rollers platform and generating control signals corresponding to the detected and measured bowness of the pipe located on the V-rollers platform after rotation;
(h) bi-directionally moving the gantry, based upon the generated control signals corresponding to the detected and measured bowness of the pipe located on the V-rollers platform after rotation, to move the plasma torch to a location to cut the second through coupling hole in the pipe; and
(i) cutting, using the plasma torch, the second through coupling hole in the pipe such that the second through coupling hole diametrically opposes the first through coupling hole.

11. The method as claimed in claim 9, further comprising:
(f) bi-directionally rotating, before the plasma torch cuts the first through coupling hole in the pipe, the gantry, using a torch orientation controller, based upon the generated control signals corresponding to the detected and measured bowness of the pipe located on the V-rollers platform.

12. The method, as claimed in claim 9, wherein said (b) detecting and measuring bowness of the pipe located on the V-rollers platform uses a non-laser based imaging device.

13. The method, as claimed in claim 9, wherein said (b) detecting and measuring bowness of the pipe located on the V-rollers platform uses a laser based imaging device.
